(19) United States
(12) Patent Application Publication
(10) Pub. No.: US 2026/0070788 A1
(43) Pub. Date: Mar. 12, 2026

(54) A method for producing ferrous sulphate and phosphoric acid

(71) Applicant: Kemira Oyj, Helsinki (FI)

(72) Inventors: Bengt HANSEN, Helsingborg (SE); Roger BÅRSTRÖM, Helsingborg (SE)

(21) Appl. No.: 18/846,676

(22) PCT Filed: Mar. 22, 2023
(86) PCT No.: PCT/FI2023/050164

§ 371 Date: Sep. 13, 2024

(30) Foreign Application Priority Data
Mar. 29, 2022 (FI) 20225265

(51) Int. Cl. C01B 25/222; C01G 49/14; C05B 13/04

(52) U.S. Cl. CPC C01B 25/222; C01G 49/14; C05B 13/04

(57) ABSTRACT

There is provided a method for producing ferrous sulphate and phosphoric acid comprising treating ferrous phosphate with sulphuric acid for obtaining ferrous sulphate and phosphoric acid. Additionally, there is provided a use of sulphuric acid for treating ferrous phosphate for obtaining ferrous sulphate and phosphoric acid.

### TECHNICAL FIELD

The present disclosure generally relates to a method for producing ferrous sulphate and phosphoric acid. The disclosure relates particularly, though not exclusively, to a method for producing ferrous sulphate and phosphoric acid by treating ferrous phosphate with sulphuric acid.

### BACKGROUND

This section illustrates useful background information without admission of any technique described herein representative of the state of the art.

Phosphorus is a naturally occurring nutrient found in soil and rocks that is required by all living organisms. Phosphorus (phosphates), together with nitrogen (nitrates), is an essential plant nutrient that is readily taken up by plants for growth. However, when these nutrients are available in unwanted excessive amounts, they can fuel rapid plant growth-which is why they are used extensively in fertilisers. High levels of phosphates in aquatic environments can fuel algal growth, resulting in algal blooms that can potentially lead to eutrophication as the thick algal mats block out sunlight causing the algal cells to die off. Oxygen is stripped from the water column as the dead algae cells decompose, leading to anoxic conditions that can result in mass die-offs of fish and other aquatic life.

Wastewater treatment systems that are commonly used to reduce biochemical oxygen demand (BOD), nitrogen and phosphorous to acceptable levels. In order to protect the environment, industrial and municipal wastewater treatment plants are tasked with reducing the levels of contaminants, including phosphorus, so that the treated effluent meets environmental standards before it is discharged into a local water body.

There are two methods of removing phosphorus from wastewater: biological removal and chemical removal. Biological phosphorus removal can be achieved by cycling the activated sludge in anaerobic and aerobic conditions, which can build up a population of microorganisms that are capable of storing phosphorus intracellularly as polyphosphate. If these specific microorganisms exist in sufficient numbers, then the phosphorus will be removed along with the waste activated sludge.

Chemical removal of phosphorus can be carried out by dosing a metal-based coagulant, most often iron-based coagulant into the wastewater. Also, aluminium based coagulants are commonly used. If an iron salt is used for phosphorus removal, both ferrous and ferric iron can be used. With the ferric iron the phosphate is separated via two routes, (i) when iron is added to wastewater it reacts with phosphates present in the wastewater, forming ferric phosphate, which is insoluble; (ii) the iron ions hydrolyse in water, forming a dense, gel-like flocs (ferric hydroxide), to which the phosphate is adsorbed. When ferrous iron is used for phosphate separation other routes than the two mentioned for ferric can occur. Commonly ferrous is oxidized to ferric in the water treatment process and then the route (i) and (ii) will be used for phosphate separation. If the ferrous is not oxidized, ferrous phosphate will be precipitated if pH is near neutral or some pH units above neutral. It is also possible that some ferrous iron hydrolyzes with water and form ferrous hydroxide flocs that can adsorb phosphates. But in most cases the iron is oxidized and ferrous hydroxides will not be present.

The precipitated iron phosphates and the iron hydroxide flocs with adsorbed phosphate will end up in the sewage sludge. These sludges rapidly become septic and ferric iron is reduced to ferrous iron. When this happens, the phosphate will re-precipitate as ferrous phosphate. The ferrous phosphate is mainly formed in sludge and both in sludge storage but mainly in anaerobic digesters. For removing the ferrous phosphate from the wastewater and/or sludge magnetic means or methods utilizing magnets can be used.

Vivianite mineral is found in several geological environments. Small amounts of manganese Mn²⁺, magnesium Mg and calcium Ca may substitute for iron Fe²⁺ in the structure.

The ferrous phosphate originating from sludge of a wastewater treatment plant is amorphous. Mineral vivianite has different structure than the amorphous ferrous phosphate originating from sludge.

The ferrous phosphate can be further used in variety of applications, such as to precipitate sulphide ions and as iron fertilizer. It is commonly known that iron can be separated from the phosphate in alkali environment, to generate two products: iron product to be used in coagulant production and phosphate based product to be used as a fertilizer.

There is still a need for new methods for separating iron and phosphate of ferrous phosphate.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

In a first aspect the present invention provides a method for producing ferrous sulphate and phosphoric acid comprising
treating ferrous phosphate with sulphuric acid for producing a mixture comprising ferrous sulphate and phosphoric acid;
cooling the mixture for precipitating ferrous sulphate; and
recovering ferrous sulphate, phosphoric acid, or ferrous sulphate and phosphoric acid.

In a second aspect the present invention provides a use of sulphuric acid for treating ferrous phosphate for producing ferrous sulphate and phosphoric acid, wherein ratio of mol amount of used sulphuric acid to mol amount of iron in the ferrous phosphate is from 0.5 to 10, preferably from 1 to 10, more preferably from 1 to 8, even more preferably from 1 to 5, more even preferably from 1 to 4.

In a third aspect the present invention provides ferrous sulphate and phosphoric acid produced with the method of the present invention.

In a fourth aspect the present invention provides use of ferrous sulphate produced with the method of the present invention in a coagulant process and/or phosphoric acid solution produced with the method of the present invention as a fertilizer or for production of pure phosphoric acid and other phosphate salts.

It was surprisingly found that by treating ferrous phosphate with sulphuric acid iron and phosphate can be separated. It was surprisingly found that copperas green (FeSO₄·7H₂O i.e., ferrous sulphate or iron sulphate) and phosphoric acid can be produced by treating ferrous phosphate with sulphuric acid.

It was surprisingly found that the produced copperas is surprisingly clean, especially in heavy metal content.

It was surprisingly found that the method of the present invention provides a simple method for producing ferrous sulphate, for example to be used in coagulant process, and phosphoric acid solution to be used for example as a fertilizer or for production of pure phosphoric acid and other phosphate salts.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

FIG. 1 shows copperas green precipitate produced with the method of the present invention.

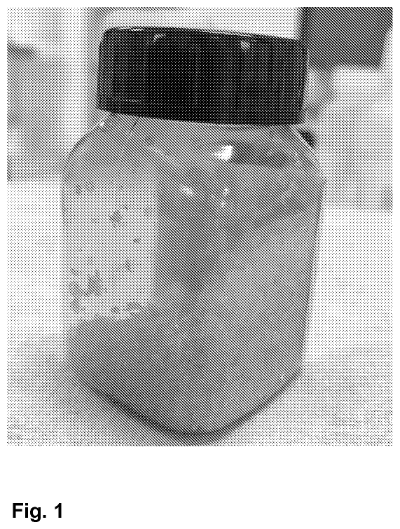

### DETAILED DESCRIPTION

In a first aspect the present invention provides a method for producing ferrous sulphate and phosphoric acid comprising
treating ferrous phosphate with sulphuric acid for producing a mixture comprising ferrous sulphate and phosphoric acid;
cooling the mixture for precipitating ferrous sulphate; and
recovering ferrous sulphate, phosphoric acid, or ferrous sulphate and phosphoric acid.

When the ferrous phosphate is treated (i.e. leached or dissolved) with sulphuric acid the ferrous phosphate dissolves and iron and phosphate separates and a mixture comprising ferrous sulphate and phosphoric acid forms.

In one embodiment the ferrous phosphate treated in the method of the present invention originates from manure, phosphate rich industrial side streams, phosphate rich industrial waste streams, wastewater treatment process, preferably from sludge, more preferably sewage sludge from wastewater treatment process. The ferrous phosphate originating from sludge is amorphous.

In one embodiment ferrous sulphate is recovered from the mixture. In another embodiment phosphoric acid is recovered from the mixture. Yet in another embodiment ferrous sulphate and phosphoric acid are recovered from the mixture.

The sulphuric acid used in the method can be concentrated sulphuric acid or diluted sulphuric acid. In one embodiment the sulphuric acid is concentrated sulphuric. In one embodiment concentration of the sulphuric acid is in the range of 40%-98.3%, preferably 60%-98%, more preferably from 90%-98.0% such as 95%-96%.

In one embodiment the mixture is cooled to a temperature range from 0° C. to 50° C., preferably from 0° C. to 30° C., more preferably from 1° C. to 15° C., even more preferably from 1° C. to 10° C., further even more preferably from 1° C. to 5° C.

In one embodiment before cooling the mixture at least a part of the ferrous sulphate is precipitated from the mixture by letting the mixture to stand for a predetermined time until ferrous sulphate precipitates.

In one embodiment the precipitated ferrous sulphate is recovered from the mixture by any suitable method known in the art, preferably by filtration, sedimentation or centrifugation.

In one embodiment the recovered precipitated ferrous sulphate is washed, preferably with sulphuric acid.

In one embodiment a filtrate comprising phosphoric acid is recovered from the filtration.

In one embodiment a liquid comprising phosphoric acid is recovered after the sedimentation.

In one embodiment a supernatant comprising phosphoric acid is recovered from the centrifugation.

In one embodiment phosphoric acid is separated from the filtrate, from the liquid, from the supernatant, or from the filtrate, from the liquid and from the supernatant, preferably in an acid regeneration process.

The acid regeneration process can be any suitable acid regeneration process known in the art. Examples of suitable acid regeneration processes are acid retardation, ion exchange and distillation.

The ferrous phosphate may contain impurities or residuals, i.e., other compounds or substances than ferrous phosphate, such as organic matter and inorganic compounds or substances. Examples of organic matter and inorganic compounds or substances are cellulose fibres, biomass, sand, manganese, magnesium, calcium and silica.

In one embodiment impurities are removed from the mixture after the treatment but before cooling the mixture, preferably by filtration or centrifugation.

In one embodiment ferrous phosphate is treated with sulphuric acid at room temperature.

In one embodiment temperature of the mixture during the treatment is elevated.

In one embodiment temperature of the mixture during the treatment is from 15° C. to 100° C., preferably from 20° C. to 100° C., more preferably from 40° C. to 100° C., even more preferably from 60° C. to 80° C.

The ferrous phosphate can be treated with any suitable amount of sulphuric acid that produces ferrous sulphate and phosphoric acid. In one embodiment ferrous phosphate is treated with excess mol amount of sulphuric acid to mol amount of iron in the ferrous phosphate.

In one embodiment ratio of mol amount of sulphuric acid to mol amount of iron in the ferrous phosphate is from 0.5 to 10, preferably from 1 to 10, more preferably from 1 to 8, even more preferably from 1 to 5, more even preferably from 1 to 4.

In another embodiment ratio of mol amount of sulphuric acid to mol amount of iron in the ferrous phosphate is from 1 to 2, preferably from 1.5 to 2 and from 2.2 to 10, preferably from 2.2 to 8, more preferably 2.2 to 6, even more preferably from 2.2 to 4.

In one embodiment the treatment of ferrous phosphate with sulphuric acid is assisted by mixing, i.e. mixing is applied in the treatment.

In one embodiment the ferrous phosphate is treated with sulphuric acid in a liquid medium, preferably in aqueous liquid medium, more preferably in water.

In one embodiment before the treatment the ferrous phosphate has solid content of at least 5%, preferably from 10% to 90%, more preferably from 15% to 80%, even more preferably from 15% to 70%, such as from 15% to 45%.

In a second aspect the present invention provides a use of sulphuric acid for treating ferrous phosphate for producing ferrous sulphate and phosphoric acid, wherein ratio of mol amount of used sulphuric acid to mol amount of iron in the ferrous phosphate is from 0.5 to 10, preferably from 1 to 10, more preferably from 1 to 8, even more preferably from 1 to 5, more even preferably from 1 to 4.

In one embodiment the ratio of mol amount of sulphuric acid to mol amount of iron in the ferrous phosphate is from 1 to 2, preferably from 1.5 to 2 and from 2.2 to 10, preferably from 2.2 to 8, more preferably 2.2 to 6, even more preferably from 2.2 to 4.

In a third aspect the present invention provides ferrous sulphate and phosphoric acid produced with the method of the present invention.

In a fourth aspect the present invention provides use of ferrous sulphate produced with the method of the present invention in a coagulant process or phosphoric acid solution produced with the method of the present invention as a fertilizer or for production of pure phosphoric acid and other phosphate salts.

### EXAMPLES

### Example, According to the Present Invention

Wet ferrous phosphate raw material originating from sludge having dry solids content of about 30% (5-10% of the solid material was organic carbon) was treated with concentrated sulphuric acid in the different molar proportions dissolving the ferrous phosphate followed by filtering the sample to remove as much organic carbon as possible.

Table 1 shows the used molar proportions and shows an indication of the total amount of copperas that was produced and where the phosphorous ends up.

With molar ratio of 1.5 and 2 a precipitation of copperas occurred already in room temperature. This precipitated copperas was separated by filtration. The filtrate was cooled down and further precipitation of copperas occurred.

With molar ratio of 1 and 4 no precipitation in room temperature occurred. Precipitation of copperas occurred after cooling, and precipitated copperas was filtered.

The mass balance of table 1 is not complete, but it gives an indication of the total amount of copperas that was produced and where the phosphorous ends up. At the molar ratio of 4:1 it is believed that a lot of the ferrous sulphate was precipitated very early and was separated with the organic fraction.

TABLE 1

| | Mol S:Fe | 1 | 1.5 | 2 | 4 |
|---|---|---|---|---|---|
| Fe | In | 9.2 | 9.2 | 9.2 | 9.2 |
| Fe | Copperas ambient | 0 | 4.2721 | 4.8093 | 0 |
| Fe | Copperas 3° C. | 2.65 | 1.44 | 1.18 | 1.02 |
| Fe | Total copperas | 2.65 | 5.71 | 5.99 | 1.02 |
| Fe | Final filtrate | 3.90 | 1.70 | 1.06 | 1.19 |
| Fe | Recovery rate in | 29% | 62% | 65% | 11% |
| | copperas | | | | |
| P | In | 4.0 | 4.0 | 4.0 | 4.0 |
| P | Copperas ambient | 0.00 | 0.02 | 0.02 | 0.00 |
| P | Copperas 3° C. | 0.01 | 0.00 | 0.00 | 0.00 |
| P | Total copperas | 0.01 | 0.02 | 0.03 | 0.00 |
| P | Final filtrate | 2.51 | 2.32 | 2.43 | 2.38 |
| P | Recovery rate in | 63% | 58% | 61% | 59% |
| | filtrate | | | | |

Table 2 shows analysis of copperas in the different fractions.

TABLE 2

| | Mol S:Fe | | | | | | | |
|---|---|---|---|---|---|---|---|---|
| | 1 | | 1.5 | | 2 | | 4 | |
| Cake | Ambient | 3° C. | Ambient | 3° C. | Ambient | 3° C. | Ambient | 3° C. |
| Fe mg/kg | | 160000 | 170000 | 180000 | 170000 | 170000 | | 170000 |
| P mg/kg | | 3500 | 3700 | 2700 | 5000 | 5000 | | 4000 |
| Ca mg/kg | | 56 | 32 | 27 | 27 | 27 | | 220 |
| Mg mg/kg | | 3300 | 3600 | 4400 | 3600 | 3600 | | 3400 |
| Al mg/kg | | 78 | 75 | 60 | 100 | 100 | | 100 |
| Si mg/kg | | <10 | <10 | 7 | <10 | <10 | | 6 |
| S mg/kg | | 98000 | 89000 | 97000 | 96000 | 96000 | | 92000 |
| C-tot mg/kg | | <0.1 | <0.1 | <0.1 | <0.1 | <0.1 | | <0.1 |
| N-tot mg/kg | | <1000 | <1000 | <1000 | <1000 | <1000 | | <1000 |
| As mg/kg | | <60 | <60 | <60 | <60 | <60 | | <60 |
| Cd mg/kg | | <5 | <5 | <5 | <5 | <5 | | <5 |
| Co mg/kg | | <5 | <5 | <5 | <5 | <5 | | <5 |
| Cr mg/kg | | <5 | <5 | <5 | <5 | <5 | | <5 |
| Cu mg/kg | | <5 | <5 | <5 | <5 | <5 | | <5 |
| Hg mg/kg | | <0.005 | <0.005 | <0.005 | <0.005 | <0.005 | | <0.006 |
| Zn mg/hg | | 110 | 120 | 180 | 130 | 130 | | 160 |
| Pb mg/kg | | <20 | <20 | <20 | <20 | <20 | | <20 |
| Mn mg/kg | | 240 | 280 | 410 | 280 | 280 | | 320 |
| Ni mg/kg | | <5 | <5 | <5 | <5 | <5 | | <5 |

Table 3 shows the content in the filtrate after the final filtration.

TABLE 3

| Mol S:Fe | 1 | 1.5 | 2 | 4 |
|---|---|---|---|---|
| Fe mg/kg | 59000 | 30000 | 20000 | 14000 |
| P mg/kg | 38000 | 41000 | 46000 | 28000 |
| Ca mg/kg | 590 | 400 | 160 | 38 |
| Mg mg/kg | 3000 | 2400 | 2200 | 1500 |
| Al mg/kg | 860 | 860 | 880 | 600 |
| Si mg/kg | 70 | 40 | 26 | 6 |
| S mg/kg | 21000 | 29000 | 45000 | 87000 |
| C-tot | 2000 | 3000 | 4000 | 5000 |
| mg/kg | | | | |
| N-tot | <1000 | 1000 | 1000 | 2000 |
| mg/kg | | | | |
| As mg/kg | <60 | <60 | <60 | <60 |
| Cd mg/kg | <5 | <5 | <5 | <5 |
| Co mg/kg | <5 | <5 | <5 | <5 |
| Cr mg/kg | <5 | 7 | 8 | 8 |
| Cu mg/kg | <5 | <5 | <5 | <5 |
| Hg mg/kg | <0.005 | <0.005 | <0.005 | <0.005 |
| Zn mg/hg | 84 | 82 | 60 | 30 |
| Pb mg/kg | <20 | <20 | <20 | <20 |
| Mn mg/kg | 400 | 310 | 300 | 74 |
| Ni mg/kg | <5 | <5 | <5 | <5 |

Various embodiments have been presented. It should be appreciated that in this document, words comprise, include, and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

This complete listing of the claims replaces all prior versions in this application:

1. A method for producing ferrous sulphate and phosphoric acid comprising
treating ferrous phosphate with sulphuric acid for producing a mixture comprising ferrous sulphate and phosphoric acid;
cooling the mixture for precipitating ferrous sulphate; and
recovering ferrous sulphate, phosphoric acid, or ferrous sulphate and phosphoric acid from the cooled mixture.

2. The method according to claim 1, wherein the ferrous phosphate originates from manure, phosphate rich industrial side streams, phosphate rich industrial waste streams, wastewater treatment process, preferably from sludge, such as sewage sludge from wastewater treatment process.

3. The method according to claim 1, wherein impurities are removed from the mixture before cooling the mixture, preferably by filtration.

4. The method according to claim 1, wherein the mixture is cooled to a temperature range from 0° C. to 50° C., preferably from 0° C. to 30° C., more preferably from 1° C. to 15° C., even more preferably from 1° C. to 10° C., further even more preferably from 1° C. to 5° C.

5. The method according to claim 1, wherein the precipitated ferrous sulphate is recovered from the mixture, preferably by filtration, sedimentation or centrifugation.

6. The method according to claim 1, wherein the recovered precipitated ferrous sulphate is washed, preferably with sulphuric acid.

7. The method according to claim 1, wherein ferrous phosphate is treated with excess amount of sulphuric acid.

8. The method according to claim 1, wherein ratio of mol amount of sulphuric acid to mol amount of iron in the ferrous phosphate is from 0.5 to 10, preferably from 1 to 10, more preferably from 1 to 8, even more preferably from 1 to 5, more even preferably from 1 to 4.

9. The method according to claim 1, wherein mixing is applied in the treatment.

10. The method according to claim 1, wherein before the treatment the ferrous phosphate has at least 5% solid content, preferably from 10% to 90%, more preferably 20% to 80%.

11. The method according to claim 5, wherein a filtrate comprising phosphoric acid from the filtration and/or a supernatant comprising phosphoric acid from the centrifugation is recovered.

12. The method according to claim 1311, wherein phosphoric acid is separated from the filtrate and/or from the supernatant, preferably in an acid regeneration process.

13. A method of producing ferrous sulphate and phosphoric acid by using sulphuric acid for treating ferrous phosphate, wherein a ratio of mol amount of used sulphuric acid to mol amount of iron in the ferrous phosphate is 0.5 to 10, preferably from 1 to 10, more preferably from 1 to 8, even more preferably from 1 to 5, more even preferably from 1 to 4.

14. Ferrous sulphate and/or phosphoric acid produced with the method according to claim 1.

15. Use of ferrous sulphate produced with the method according to claim 1 in a coagulant process or phosphoric acid solution produced with the method of according to claim 1 as a fertilizer or for production of pure phosphoric acid and other phosphate salts.

16. The method of claim 1, wherein the concentration of the sulphuric acid is in the range of 40%-98.3%.
